(19) United States
(12) Patent Application Publication
(10) Pub. No.: US 2005/0011487 A1
(43) Pub. Date: Jan. 20, 2005

(54) One cycle/dual piston engine

(76) Inventor: Arthur Earl Warren JR., Dauphin, PA (US)

Correspondence Address: Arthur Warren, Jr., 311 Speece Lane, Dauphin, PA, 17018, US

(21) Appl. No.: 10/892,073

(22) Filed: Jul. 15, 2004

Related U.S. Application Data
(60) Provisional application No. 60/488,462, filed on Jul. 18, 2003.

(51) Int. Cl. F02B 3/00; F02B 75/16

(52) U.S. Cl. 123/305; 123/61 R

(57) ABSTRACT

A one cycle internal combustion engine design employing a single piston that is fired at both ends of its cylinder—called a “dual piston”, in combination with a vortex head at each end of the cylinder that has a single, two-step valve and a turbo tip injector or fuel injector tip, and the use of a connecting link, rolling fulcrum and journal rod assembly for multiplying torque.

### CROSS-REFERENCE TO RELATED APPLICATIONS

This application claims the benefit of provisional patent application Ser. No. 60/488,462, filed Jul. 18, 2003 on behalf of the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to a one cycle internal combustion engine design employing a single piston that is fired at both ends of its cylinder—called a “dual piston”—with a connecting link, rolling fulcrum and journal rod assembly for multiplying torque and having a vortex head at each end of the cylinder with a single, two-step valve and turbo tip injector or fuel injector tip.

### BACKGROUND OF INVENTION

2. Prior Art

The use of the internal combustion engine, in a variety of configurations, is well-known in the prior art. In addition to the basically familiar, expected and obvious structural configurations for the internal combustion engine, the known prior art does include a configuration employing a pair of pistons in opposed cylinder heads connected to an oscillating lever arm. See U.S. Pat. No. 5,572,904. Although the known configurations fulfill their respective, particular objectives and requirements, the existing patents, including U.S. Pat. No. 5,572,904, do not disclose a one cycle engine employing a “dual piston” and the use of a connecting link, rolling fulcrum and journal rod assembly for multiplying torque, combined with a vortex head at each end of the cylinder that has a single, two-step valve and a turbo tip injector or fuel injector tip.

### BACKGROUND OF INVENTION—OBJECTS AND ADVANTAGES

The present invention has several objects and advantages to prior art, as follows:
(a) to greatly increase the power generated by an internal combustion engine;
(b) to greatly increase the fuel efficiency of an internal combustion engine;
(c) to eliminate drag due to resistance from non-powered piston movement within an internal combustion engine.

### SUMMARY

In accordance with the present invention a one cycle, dual piston internal combustion engine comprises one or more cylinders that contain a “dual piston” capable of firing at the top and bottom of the cylinder and attached to a connecting link that runs from the center of the piston to a journal rod on the crank shaft, which connecting link is attached by a pin to a rolling fulcrum, which fulcrum slides on roller bearings, thereby multiplying the energy transferred from movement of the dual piston to the crank—via the connecting link. The pin attaching the connecting link to the fulcrum can also be off-set on the link to achieve different stroke, horsepower and torque and realize substantially greater fuel efficiency.

The one cycle engine/dual piston engine also employs a unique vortex head assembly which creates a vacuum effect inside the injector valve housing/fire chamber assembly that forces exhaust gases out and draws fresh air in for the next firing.

The most important features of the invention have been broadly outlined above so that the following detailed description can be better understood and so that its contribution to the existing art can be better appreciated. It should be noted that the present invention is not limited in its application to the following detailed description or illustrative drawings. The invention can be employed in a variety of embodiments and constructions. Therefore, the claims set forth in this application should be regarded as including equivalent embodiments and constructions to the extent they do not significantly depart from the spirit and scope of the present invention.

In the drawings, closely related figures have the same number but different alphabetic suffixes.

### DRAWINGS—FIGURES

FIG. 1A shows front, open view of engine block and cylinders [w/dual pistons] and vortex heads

FIG. 1B shows open view of rolling fulcrum assemblies connected to two dual pistons [in two cylinders] to a single crank shaft

FIG. 1C shows side, top and front view of a rolling fulcrum assembly

FIG. 1D depicts a journal rod

FIG. 1E depicts a connecting link

FIG. 1F depicts a dual piston, showing cut-outs on top and bottom

FIG. 2 shows a front, open view of block and cylinder [one at 90 degree view], open view of vortex head

FIG. 3A shows a front open view of vortex head with cam at 90 degree view

FIG. 3B similar to 3A with valve open

FIG. 3C shows cut away view of turbo injector tip and fire chamber

FIG. 3D shows cut away view of injector tip and fire chamber

FIG. 3E shows cut away view of vortex head and air flow through fire chamber

FIG. 3F shows vortex head—top, side and front views

FIG. 4A shows top view of engine

FIG. 4B shows engine with intake and exhaust pipes

### DRAWINGS—REFERENCE NUMERALS

10 Engine Block 12 Cylinder
14 Dual Piston 16 Piston Rings
18 Fuel Supply Tube 20 Fuel Supply Bridge
22 Cam Shaft 24 Cam gear
26 Umbrella Seat 28 Valve Spring
30 Vortex Head 32 Back Flap
34 Upper Intake Port w/Back Flap 36 Lower Intake Port
38 Exhaust Port 40 Injector Valve Fire Chamber Housing
42 Turbo Tip Injector 44 Cam Mount Bracket
46 Fulcrum Roller Bearings
50 Rolling Fulcrum 52 Rolling Fulcrum Mount Bracket
54 Connecting Link 56 Journal Rod
58 Rolling Fulcrum Center Pin 60 Dual Piston Pin
62 Journal Rod to Connecting Link Pin
70 Journal Rod Pin 72 Crank Gear
74 Crank Shaft 76 Serpentine Belt
78 Rolling Belt Tensioner 80 Idler Pulley
90 Oil Pan
100 Valve Stem Turbo Tip Injector 102 Valve Spring Retainer
110 Valve Seat Spring Retainer 120 Valve Seat Spring
140 Intake Port From Vortex Head 150 Turbo Tip Bearing
160 Intake Export 170 Valve Seat Stop
200 Valve Stem 210 Injector Tip
300 Flywheel 310 Rear Cover
320 Intake Pipe 330 Exhaust Pipe
340 Turbo

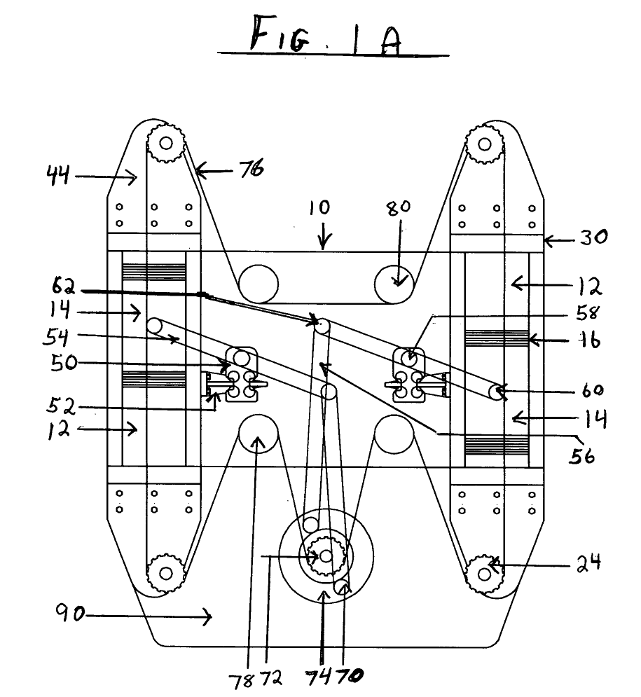

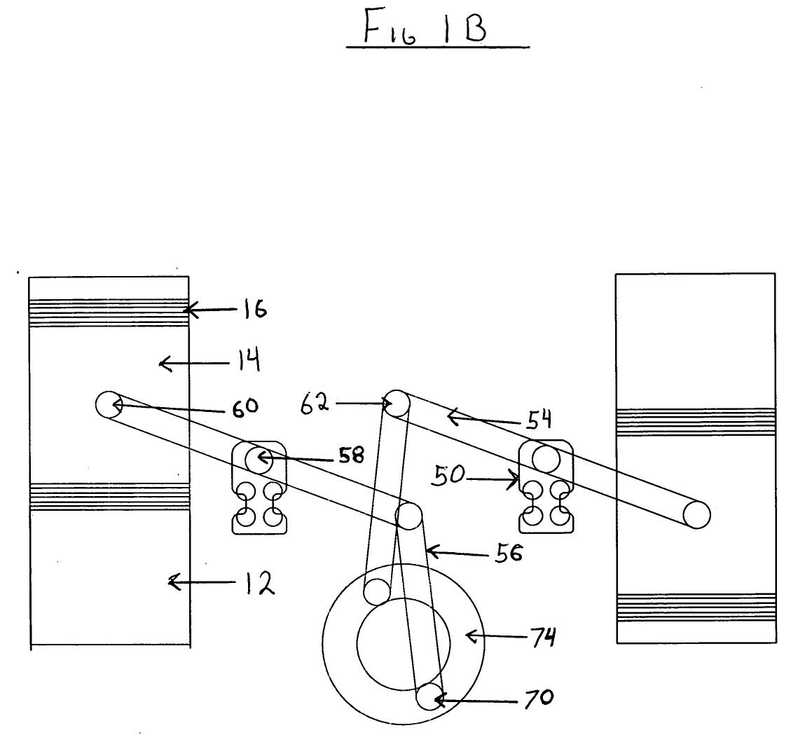

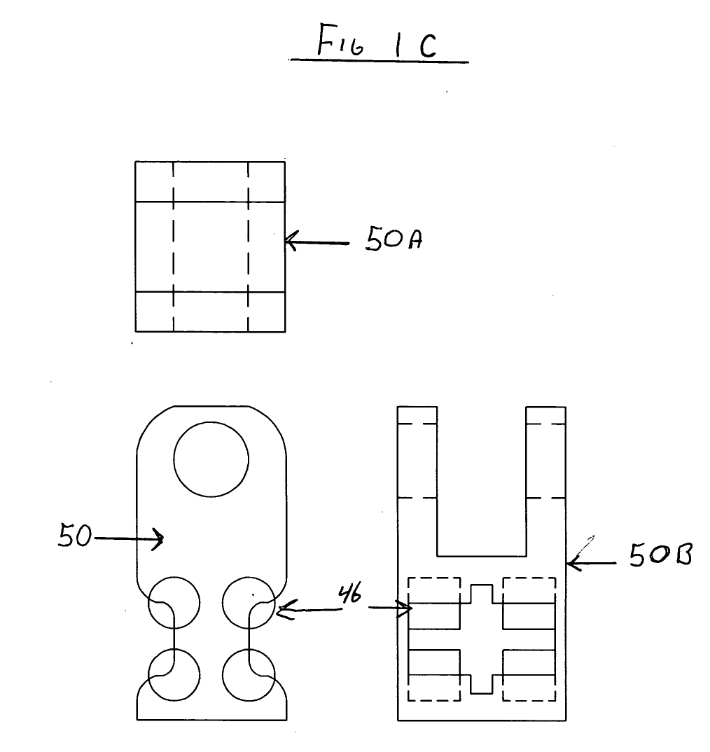

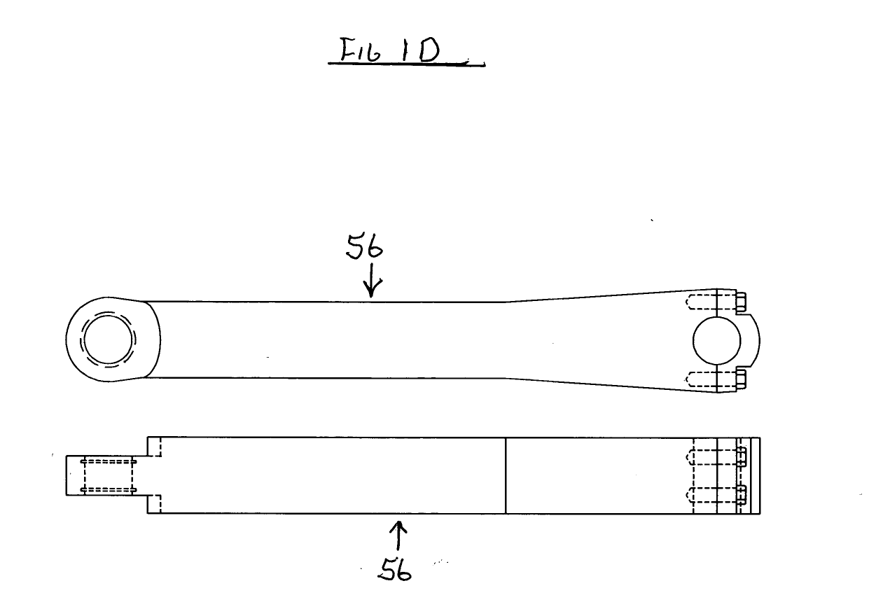

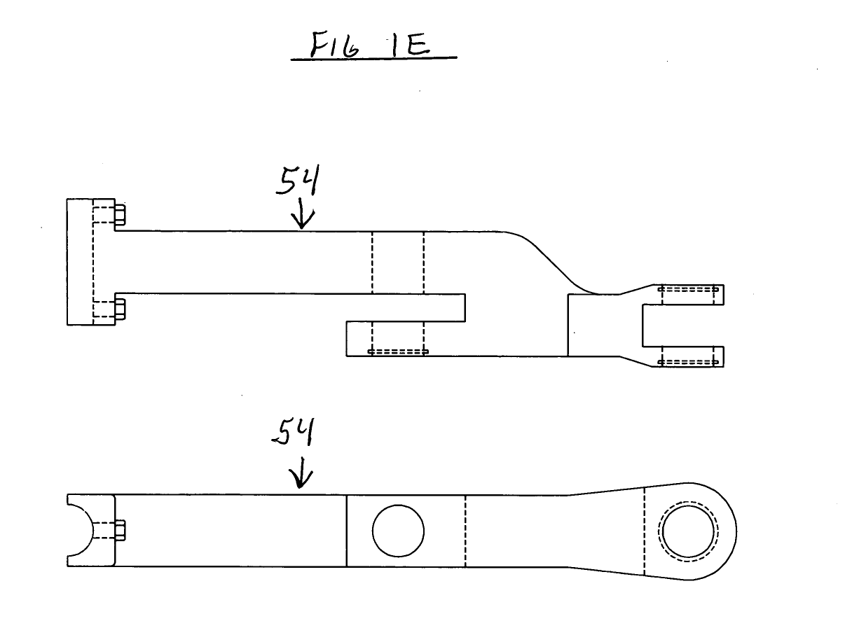

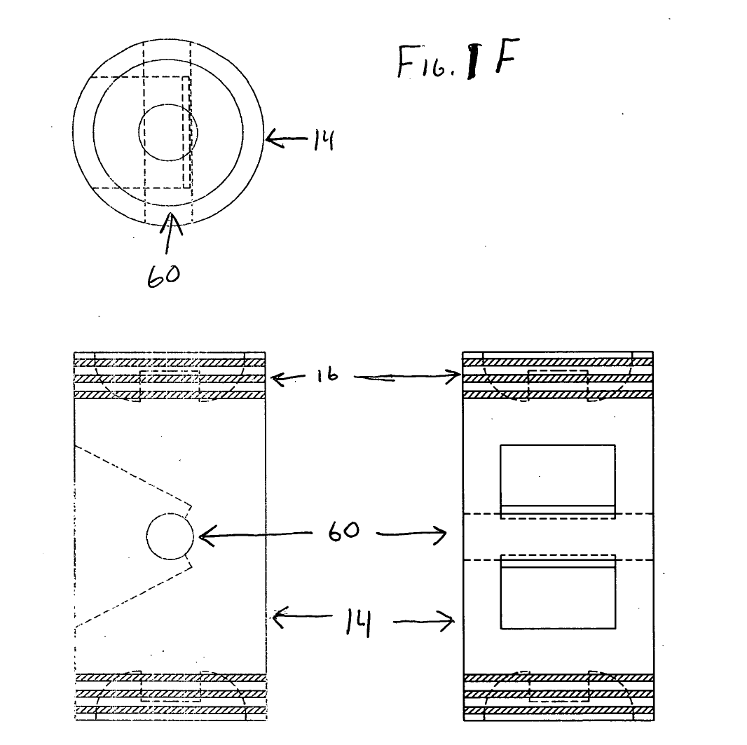

### DETAILED DESCRIPTION—FIGS. 1A-F, 2, 3A-C, 4A-B—PREFERRED EMBODIMENT

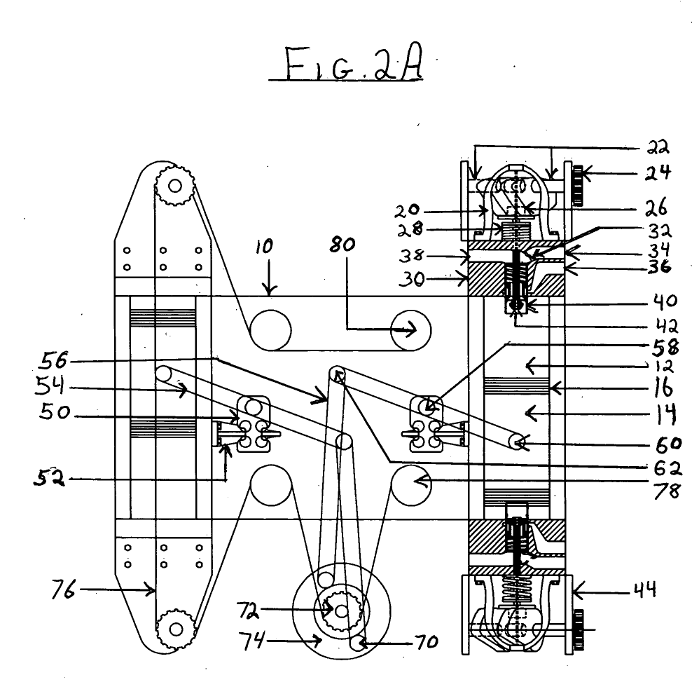

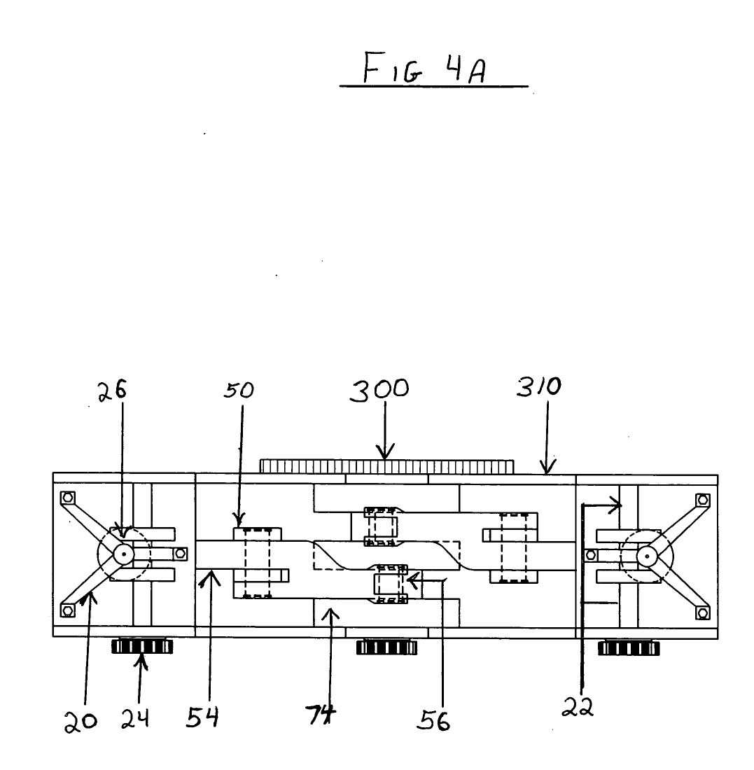

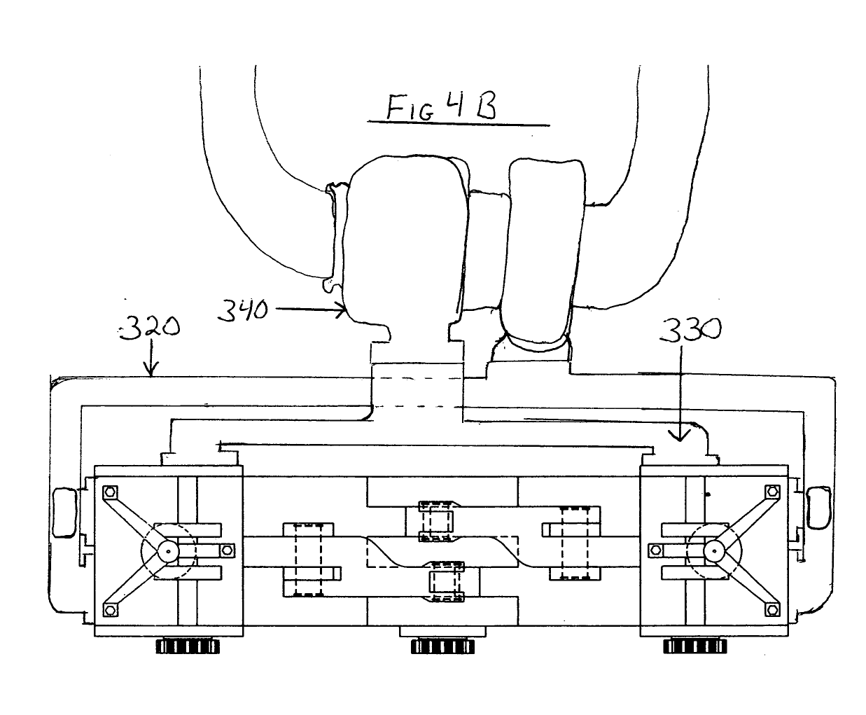

FIGS. 1A and 2 are identical, both showing the front view of an engine block (10) in a two cylinder (12) configuration, each cylinder containing a dual piston (14), and vortex heads (30), with the only exceptions being that FIG. 2 shows the right cylinder/dual piston/vortex head(s) in a cut away view rotated 90 degrees and does not show the oil pan. A top view of the engine is depicted in FIG. 4A, including a view of rear cover (300) and flywheel (310). Another top view, showing intake pipe (320), exhaust pipe (330) and turbo (340) is presented in FIG. 4B.

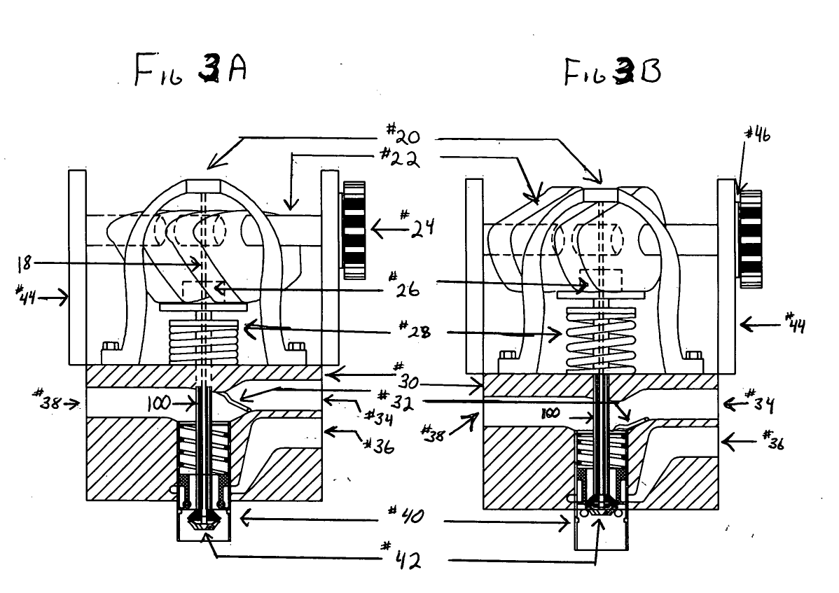

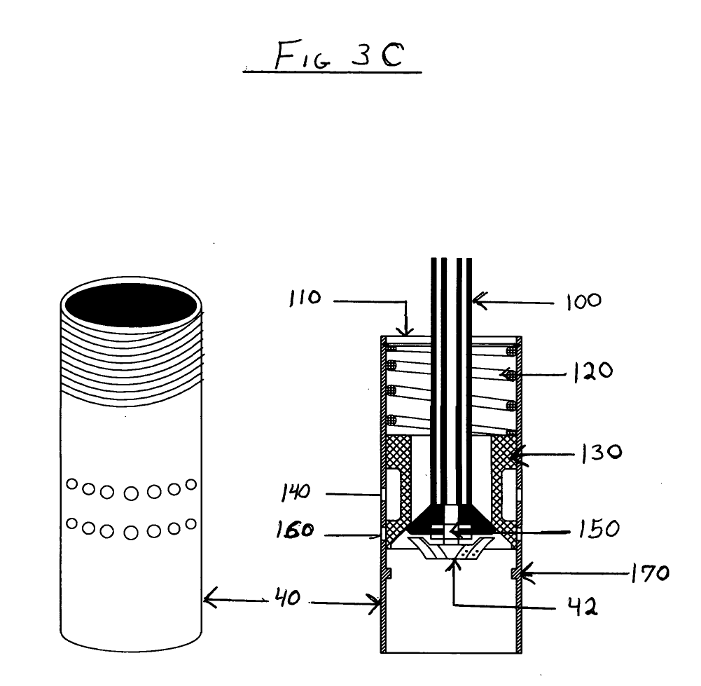

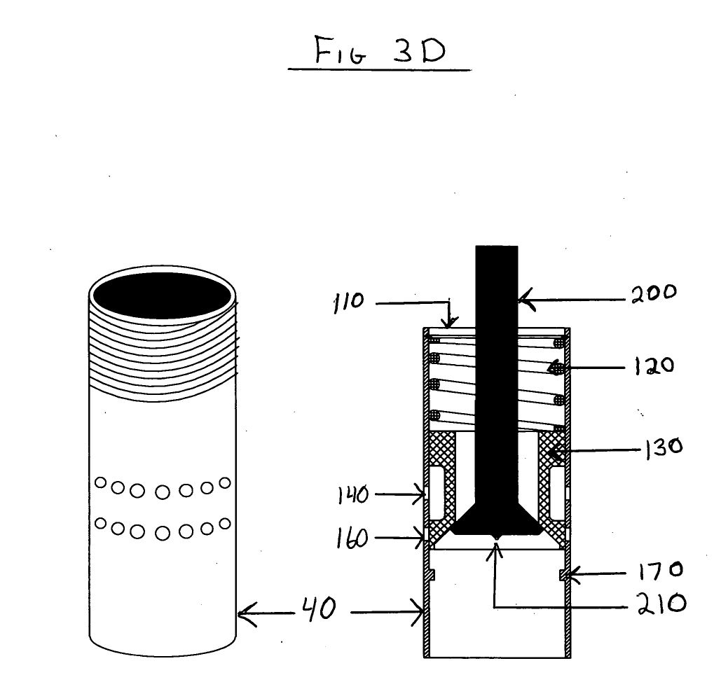

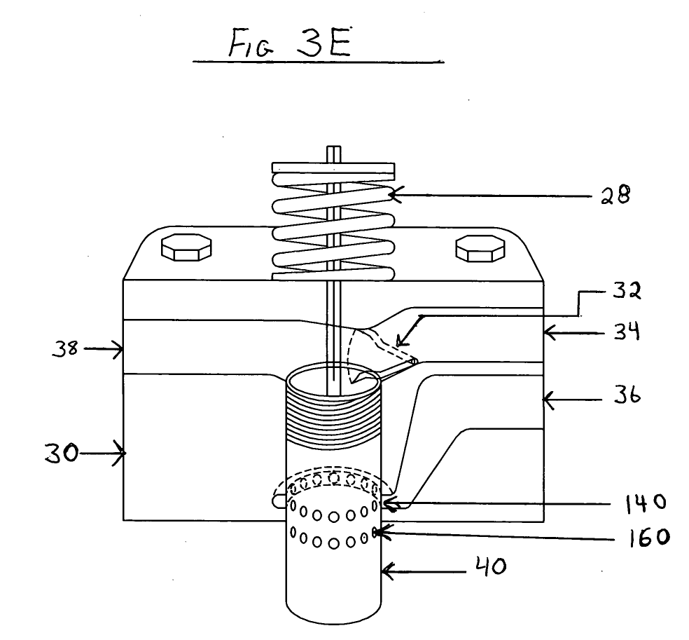

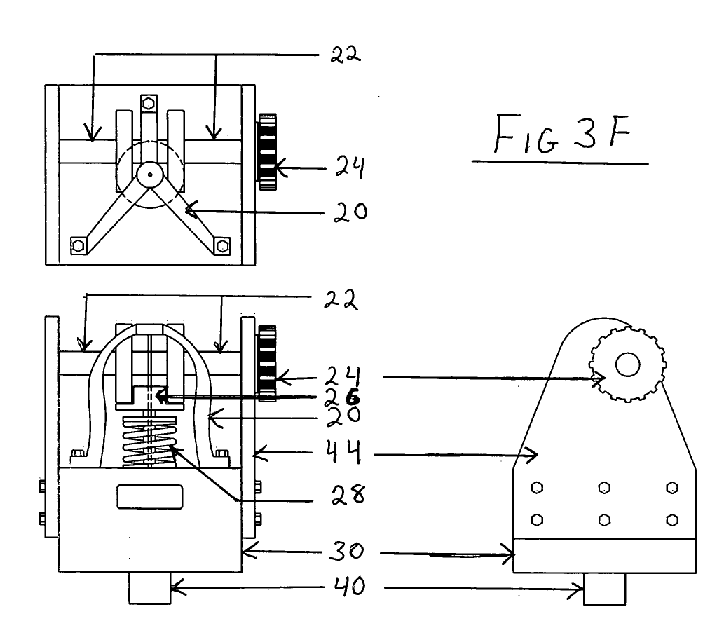

Said dual piston (14) is a single piston that fires every time it reaches the top and bottom of its cylinder (12)—thus making this invention a one cycle engine. Said dual piston (14) has a cut-out on top and bottom so that it can fit over the injector fire chamber housing (40). FIG. 3C depicts the injector fire chamber housing (40), together with the turbo tip injector (42), valve stem turbo tip injector (100), valve seat spring retainer (110), valve seat spring (120), intake port from vortex head (140), turbo tip bearing (150), intake export (160), and valve seat stop (170). This single valve assembly controls both the intake and exhaust functions of the unique vortex head (30).

The cut away view illustrating the details of the vortex head is depicted in FIGS. 3A and 3B (3A with valve in the open position and 3B in the closed position), including: fuel supply tube (18), fuel supply bridge (20), cam shaft (22)—with mount bracket (44), cam shaft gear (24), umbrella seat (26), valve spring (28), valve spring retainer (102), back flap (32), upper intake port (34), lower intake port (36), exhaust port (38), injector valve fire chamber housing (40), turbo tip injector (42), and valve stem turbo tip injector (100). Top, front and side views of the vortex head are depicted in FIG. 3F.

FIG. 1B depicts an assembly consisting of a connecting link (54), rolling fulcrum (50) and journal rod (56), connected at one end by a pin (60) to the center of a dual piston (14) and at the other end to a crank shaft (74). Said connecting link (54) is attached by a center pin (58) to a rolling fulcrum (50) and to a journal rod (56) by a center pin (62). Separate views of a rolling fulcrum, journal rod and connecting link are depicted in FIGS. 1C, 1D and 1E, respectively. The said connecting link (54) being attached by a pin (60) to the center of a dual piston (14) and by another pin (62) to a journal rod (56) which is attached to a crank shaft (74), is also attached by a center pin (58) to a rolling fulcrum (50), which fulcrum slides on multiple roller bearings [eight shown] (46), thereby multiplying the energy transferred from movement of the dual piston (14) to the crank (74)—via the connecting link (54). The said center pin (58) attaching said connecting link (54) to said rolling fulcrum (50) can also be off-set on said connecting link (54) to achieve different stroke, horsepower and torque and realize substantially greater fuel efficiency.

Operation—FIGS. 1A-F, 2, 3A-C, 4A-B

When a starter means engaging a flywheel (300) is powered, a crank shaft (74) is turned. As said crank shaft (74) begins to turn it moves a journal rod (56) up and down in a circular motion. Said journal rod (56) is attached by a pin (62) to a connecting link (54) which pivots on a rolling fulcrum (50)—allowing said connecting link to move up and down in a rocking motion as the dual piston (14) to which its opposite end is attached moves up and down in its cylinder(12). Said rolling fulcrum (50) to be mounted on multiple [eight shown] rolling bearings (46) along amounted bracket guide (52).

Said dual piston (14) fires every time it reaches the top and bottom of its cylinder (12)—with air being drawn in, mixed with fuel and compressed and, after the fuel is fired, exhausted all in one stroke—thus making this invention a one cycle engine. The dual piston (14) has a cut-out on top and bottom so that it can fit over the injector fire chamber housing (40). FIG. 3C depicts the injector fire chamber housing (40), together with a turbo tip injector (42), valve stem turbo tip injector (100), valve seat spring retainer (110), valve seat spring (120), intake port from vortex head (140), turbo tip bearing (150), intake export (160), and valve seat stop (170). This single valve assembly controls both the intake and exhaust functions of the unique vortex head (30). Fresh air, from a turbo (340) passes through an intake pipe (320) to a vortex head (30) having two intake ports—upper (34) and lower (36).

As said crank shaft (74) turns it also rotates, via a crank gear (72), a serpentine timing belt (76), running around tension idler pulleys (80) and rolling belt tensioners (78) and cam gears (24), thus turning a cam shaft with a lobe(s) (22) that activates valve(s). As a cam lobe presses down on an umbrella seat (26) it, in turn, presses down on a valve stem (100), said valve stem presses down a valve spring retainer (102), pressing down on a valve spring (28), allowing fresh air to enter said vortex head (30) through said intake ports (34, 36), as shown in FIG. 3A, into an injector fire chamber housing (40) through an intake port (140). Fresh air also passing through intake export (160) into the cylinder (12). The movement of said cam lobe (22) pressing on said umbrella seat (26) also allows fuel to enter an injector fire chamber housing (40) through a turbo tip injector (42) via a turbo tip injector valve stem (100) through a fuel supply tube (18) being delivered from a fuel supply bridge (20) as supplied by a fuel supply means. The pressure of fuel passing through holes in said turbo tip injector (42) spins said turbo tip injector which in turn creates a vortex of air and atomizing fuel, permitting an extremely quick fuel burn with very little wasted fuel.

When the fuel/air mixture is compressed by the movement of said dual piston (14), it fires, thereby forcing said dual piston (14) to move in an opposite direction in its cylinder (12). Before said dual piston (14) reaches the bottom of said injector fire chamber housing (40), a valve has opened, allowing the exhaust gases and heat to escape immediately and exit via an exhaust port (38), thus keeping heat out of said cylinder. Simultaneously, a back flap (32) within an upper intake port (34) moves into place across said port to keep exhaust from back feeding into the turbo inlet. The exhaust gases exit out said exhaust port (38) while pressure within said injector fire chamber housing (40) neutralizes, as said valve opens, a vacuum is created in said fire chamber housing (40). At the same time, a valve seat is opening and allowing fresh air into said fire chamber housing (40), which results in exhaust being forced out more quickly. The same function is replicated at the opposite end of the cylinder as said dual piston moves in that direction.

### FIG. 3D—ADDITIONAL EMBODIMENT

All components of the engine are the same as above, with the exception that a fuel injector tip (210) is employed in place of the turbo tip injector. Details of the injector tip valve and fire chamber assembly are shown in FIG. 3D.

Advantages

From the description above, a number of advantages of the one cycle, dual piston internal combustion engine are evident:
(a) with a single, dual piston firing at the top and bottom of its stroke there will be less drag than in existing internal combustion engines;
(b) because the rolling fulcrum will provide mechanical leverage, said engine will generate more power with less fuel consumption;
(c) the vortex head design will allow air and fuel to mix and burn more efficiently and will also allow air to flow through the ports so as to create a vacuum effect to more efficiently remove exhaust gases and heat.
   Conclusion, Ramifications, and Scope of Invention

Accordingly, the reader will see that the one cycle, dual piston internal combustion engine is a significant advancement in the design of the internal combustion engine that will allow for the generation of greater power with less fuel consumption, in addition to less wasted fuel.

The foregoing description should not be construed as limiting the scope of the invention, but simply as an example of the preferred embodiment(s). As previously noted, the invention can be employed in a variety of embodiments and constructions. Thus, the claims set forth in this application should be regarded as including equivalent embodiments and constructions to the extent they do not significantly depart from the spirit and scope of the present invention.

1. An internal combustion engine, comprising:
a. one or more single pistons that are fired at both ends of their respective cylinders—hereinafter referred to as a “dual piston,”
b. said dual piston having a cut-out at its top and bottom ends so that it can fit over an injector valve fire chamber housing,
c. said dual piston to be attached at its center via a pin to a connecting link,
d. said connecting link to pivot on a rolling fulcrum and to be attached at its oppose end via a pin to a journal rod,
e. said rolling fulcrum to be mounted on multiple rolling bearings which are mounted on a mounted bracket guide,
f. said journal rod being attached at its oppose end to a crank shaft,
g. said cylinders having a vortex cylinder head with single, two-step valve, back-flap and turbo tip injector or fuel injector tip,
h. said vortex cylinder head housing a cam shaft with lobes, umbrella seat, valve spring, valve spring retainer, upper intake port, lower intake port, exhaust port, injector valve fire chamber housing, turbo tip injector (or a fuel injector tip) and valve stem turbo tip injector,

2. A cylinder head for an internal combustion engine, comprising:
a. a cam shaft with lobes, moved by a timing belt means,
b. the lobes of said cam shaft to press upon an umbrella seat, thereby compressing a valve stem assembly,
c. compression of said valve stem assembly to allow fresh air to enter an injector valve fire chamber housing from an upper intake port—containing a back flap—and a lower intake port,
d. a turbo tip injector to protrude into said injector valve fire chamber housing,
e. said injector valve fire chamber housing to fit into a cut out on a conforming piston,
f. said turbo tip injector to move in a spinning fashion as it injects fuel into the injector valve fire chamber housing, in which the fuel/air mixture is combusted,
g. gases and heat from said combustion to escape via an exhaust port, with the escape of said gases and heat to be accelerated by incoming air.

3. A connecting link, rolling fulcrum and journal rod assembly for an internal combustion engine, comprising:
a. a connecting link that attaches via a center pin to a piston,
b. said connecting link to pivot on a rolling fulcrum and to be attached at its oppose end via a pin to a journal rod,
c. said rolling fulcrum to be mounted on eight (8) rolling bearings mounted on a mounted bracket guide,
d. said journal rod being attached at its oppose end to a crank shaft.
